(19) United States
(12) Patent Application Publication
(10) Pub. No.: US 2023/0325228 A1
(43) Pub. Date: Oct. 12, 2023

(54) PROCESS TREE-BASED PROCESS MONITORING IN ENDPOINTS

(71) Applicant: VMWARE, INC., Palo Alto, CA (US)

(72) Inventors: Atreyee Bhaduri, Bangalore (IN); Vinothkumar D, Villupuram (IN); Abhishek Singh, Bangalore (IN); Akansha Srivastava, Bangalore (IN); Venkata Padma Kaki, West Godavari (IN)

(21) Appl. No.: 17/824,902

(22) Filed: May 26, 2022

(30) Foreign Application Priority Data
Apr. 12, 2022 (IN) 202241021896

(51) Int. Cl. G06F 9/455; G06F 9/445

(52) U.S. Cl. CPC G06F 9/45558; G06F 2009/45583; G06F 2009/4557; G06F 9/44505

(57) ABSTRACT

An example system includes a first endpoint executing a remote collector and a second endpoint in communication with the first endpoint. The remote collector may monitor the second endpoint and send monitored information to a monitoring application. Further, the second endpoint may include a monitoring agent and a process tree generation unit. The process tree generation unit may receive a command to monitor an input process running in the second endpoint and download a process tree creation script from the remote collector. Further, the process tree generation unit may execute the process tree creation script to generate a configuration file for the monitoring agent. The configuration file may include a process tree indicating a hierarchical relationship of the input process with other processes. Furthermore, the process tree generation unit may enable the monitoring agent to monitor the processes in the process tree based on the configuration file.

### RELATED APPLICATIONS

Benefit is claimed under 35 U.S.C. 119(a)-(d) to Foreign Application Serial No. 202241021896 filed in India entitled “PROCESS TREE-BASED PROCESS MONITORING IN ENDPOINTS”, on Apr. 12, 2022, by VMware, Inc., which is herein incorporated in its entirety by reference for all purposes.

### TECHNICAL FIELD

The present disclosure relates to computing environments, and more particularly to methods, techniques, and systems for monitoring processes in an endpoint based on a process tree.

### BACKGROUND

In application/operating system (OS) monitoring environments, a management node that runs a monitoring tool may communicate with multiple endpoints to monitor the endpoints. For example, an endpoint may be implemented in a physical computing environment, a virtual computing environment, or a cloud computing environment. Further, the endpoints may execute different applications via virtual machines (VMs), physical host computing systems, containers, and the like. In such environments, the management node may communicate with the endpoints to collect performance data/metrics (e.g., application metrics, operating system metrics, and the like) from underlying operating system and/or services on the endpoints for storage and performance analysis (e.g., to detect and diagnose issues).

### BRIEF DESCRIPTION OF THE DRAWINGS

FIG. 1A is a block diagram of an example system, depicting a process tree generation unit to generate a configuration file for a monitoring agent to monitor processes;

FIG. 1B is a block diagram of the system of FIG. 1A, depicting additional features;

FIG. 2 is an example configuration file indicating a hierarchical relationship of an input process with other processes;

FIG. 3 is an example relationship tree constructed based on the configuration file of FIG. 2;

FIG. 4 is a flow diagram illustrating an example computer-implemented method for generating a configuration file for a monitoring agent to monitor processes in a process tree; and

FIG. 5 is a block diagram of an example endpoint including non-transitory computer-readable storage medium storing instructions to generate a configuration file including a process tree for monitoring processes in the endpoint.

The drawings described herein are for illustration purposes and are not intended to limit the scope of the present subject matter in any way.

### DETAILED DESCRIPTION

Examples described herein may provide an enhanced computer-based and/or network-based method, technique, and system to monitor processes in an endpoint based on a process tree in a computing environment. Computing environment may be a physical computing environment (e.g., an on-premises enterprise computing environment or a physical data center), a virtual computing environment (e.g., a cloud computing environment, a virtualized environment, and the like), or a hybrid of both.

The virtual computing environment may be a pool or collection of cloud infrastructure resources designed for enterprise needs. The resources may be a processor (e.g., central processing unit (CPU)), memory (e.g., random-access memory (RAM)), storage (e.g., disk space), and networking (e.g., bandwidth). Further, the virtual computing environment may be a virtual representation of the physical data center, complete with servers, storage clusters, and networking components, all of which may reside in a virtual space being hosted by one or more physical data centers. The virtual computing environment may include multiple physical computers executing different workloads (e.g., virtual machines, containers, and the like). Such workloads may execute different types of applications.

The paragraphs [0011] to [0016] are an overview of endpoint performance monitoring in computing environments, existing methods to monitor performance of the endpoint, and drawbacks associated with the existing methods. Performance monitoring of endpoints (e.g., physical host computing systems, virtual machines, software defined data centers (SDDCs), containers, and/or the like) has become increasingly important because performance monitoring may aid in troubleshooting (e.g., to rectify abnormalities or shortcomings, if any) the endpoints, provide better health of data centers, analyse the cost, capacity, and/or the like. An example performance monitoring tool or application or platform may be VMware® vRealize Operations (vROps), VMware® Wavefront™, Grafana, and the like.

Further, the endpoints may include monitoring agents (e.g., Telegraf™, Collectd, Micrometer, and the like) to collect the performance metrics from the respective endpoints and provide, via a network, the collected performance metrics to a remote collector (e.g., an application remote collector (ARC) or a cloud proxy). Furthermore, the remote collector may receive the performance metrics from the monitoring agents and transmit the performance metrics to the monitoring tool for metric analysis. A remote collector may refer to a service/program that is installed in an additional cluster node (e.g., a virtual machine). The remote collector may allow the monitoring tool (e.g., vROps Manager) to gather objects into the remote collector's inventory for monitoring purposes. The remote collectors collect the data from the endpoints and then forward the data to the management node that executes the monitoring tool. For example, remote collectors may be deployed at remote location sites while the monitoring tool may be deployed at a primary location.

Furthermore, the monitoring tool may receive the performance metrics, analyse the received performance metrics, and display the analysis in a form of dashboards, for instance. The displayed analysis may facilitate in visualizing the performance metrics and diagnose a root cause of issues, if any. In some computing environments, the monitoring tools (e.g., vROps) may be deployed and run in on-premises platform to collect data from the endpoints via the remote collectors. The term “on-premises” may refer to a software and a hardware infrastructural setup (e.g., associated with the monitoring tools) deployed and running from within the confines of an organization/enterprise.

In other computing environments, the monitoring tools (e.g., vROps) may be deployed and run-in cloud platforms (e.g., Software as a service (SaaS) platforms) to collect data from the endpoints via cloud proxies. The SaaS is a software distribution model in which a cloud provider hosts applications and makes the applications available to end users over the Internet. In an example on-premises platform, an application remote collector (ARC) or a cloud proxy is a type of remote collector that the monitoring tool (e.g., vROps) uses to collect metrics of applications running in endpoints (e.g., virtual machines) using monitoring agents. In an example SaaS platform, the cloud proxy is a type of remote collector that the monitoring tool (e.g., vROps) uses to collect metrics of applications running in endpoints (e.g., virtual machines) using monitoring agents.

In such scenarios, the remote collector (e.g., the ARC or the cloud proxy) with the help of a custom monitoring agent (e.g., Telegraf agent) supports specific applications to be monitored. Application monitoring with the help of the custom monitoring agent may ensure that the applications maintain levels of performance needed to support business outcomes. For example, the custom monitoring agent may obtain performance metrics for certain enterprise applications (e.g., curated applications supported by the monitoring agent) running on endpoints. However, the custom monitoring agent may not support other non-curated applications running on the endpoints. Thus, the customer may have to switch to an open-source monitoring agent for monitoring the non-curated applications.

Further, the custom monitoring agent may not support monitoring custom Linux processes (e.g., instances of executing a program or command on Linux® operating system), custom Windows services associated with Microsoft Windows® operating system, or both, that run on the endpoint. Furthermore, the custom monitoring agent may not be able to provide insight into parent and child processes associated with the applications. The information associated with the parent and child processes facilitate to debug memory, central processing unit (CPU), and/or availability issues of the applications. Moreover, even though existing monitoring approach generates an alert when an issue occurs, a user may have to manually check for a process of the application, which is causing the issue.

Examples described herein may provide an endpoint to enable a monitoring agent to monitor processes in the endpoint based on a process tree. The endpoint may include a monitoring agent and a process tree generation unit in communication with the monitoring agent. During operation, the process tree generation unit may receive a command to monitor an input process running in the endpoint. Further, the process tree generation unit may download a process tree creation script from a remote collector upon receiving the command. Furthermore, the process tree generation unit may execute the process tree creation script to generate a configuration file for the monitoring agent. The configuration file may include a process tree indicating a hierarchical relationship of the input process with other processes. Further, the process tree generation unit may enable the monitoring agent to monitor the processes in the process tree based on the configuration file.

Examples described herein generate the process tree/process map to monitor the parent and child processes within a boundary which affects the performance of the input process. Further, examples described herein enable to granularly monitor any application process and/or service, and to obtain a performance peek into any running process/service in the endpoint.

In the following description, for purposes of explanation, numerous specific details are set forth to provide a thorough understanding of the present techniques. It will be apparent, however, to one skilled in the art that the present apparatus, devices, and systems may be practiced without these specific details. Reference in the specification to “an example” or similar language means that a particular feature, structure, or characteristic described is included in at least that one example, but not necessarily in other examples.

System Overview and Examples of Operation

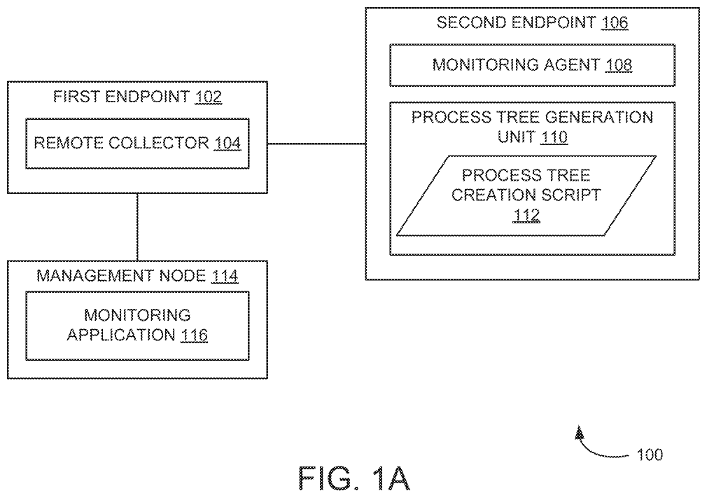

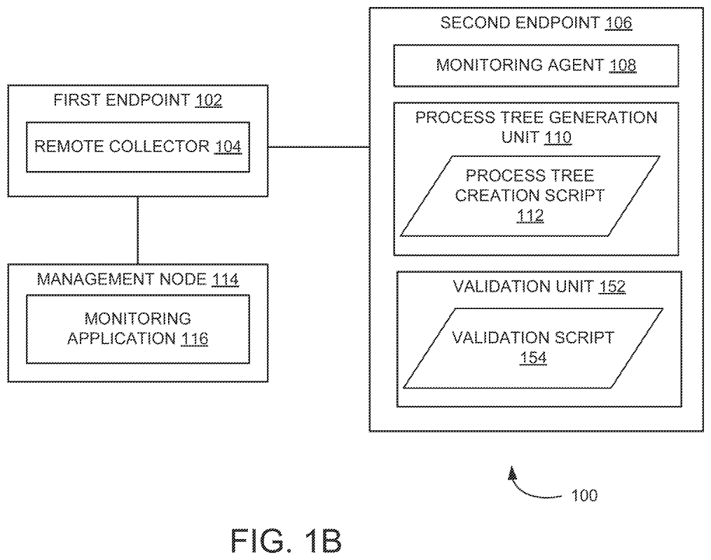

FIG. 1A is a block diagram of an example system 100, depicting a process tree generation unit 110 to generate a configuration file for a monitoring agent to monitor processes. Example system 100 may include a computing environment such as a cloud computing environment (e.g., a virtualized cloud computing environment), a physical computing environment, or a combination thereof. For example, the cloud computing environment may be enabled by vSphere®, VMware's cloud computing virtualization platform. The cloud computing environment may include one or more computing platforms that support the creation, deployment, and management of virtual machine-based cloud applications. An application, also referred to as an application program, may be a computer software package that performs a specific function directly for an end user or, in some cases, for another application. Examples of applications may include MySQL, Tomcat, Apache, word processors, database programs, web browsers, development tools, image editors, communication platforms, and the like.

As shown in FIG. 1A, example system 100 may be a data center (e.g., vCenter) including plurality of endpoints (e.g., a first endpoint 102 and a second endpoint 106). In an example, an endpoint may include, but not limited to, a virtual machine, a physical host computing system, a container, or any other computing instance that executes different applications. For example, the endpoint can be deployed either in an on-premises platform or an off-premises platform (e.g., a cloud managed software defined data center (SDDC)). An SDDC may refer to a data center where infrastructure is virtualized through abstraction, resource pooling, and automation to deliver Infrastructure-as-a-service (IAAS). Further, the SDDC may include various components such as a host computing system, a virtual machine, a container, or any combinations thereof. Example host computing system may be a physical computer. The physical computer may be a hardware-based device (e.g., a personal computer, a laptop, or the like) including an operating system (OS). The virtual machine may operate with its own guest operating system on the physical computer using resources of the physical computer virtualized by virtualization software (e.g., a hypervisor, a virtual machine monitor, and the like). The container may be a data computer node that runs on top of host operating system without the need for the hypervisor or separate operating system.

Further, system 100 includes a management node 114 to manage the data center. For example, management node 114 may execute centralized management services that may be interconnected to manage the resources centrally in the virtualized computing environment. Example centralized management service may be a part of vCenter Server™ and vSphere® program products, which are commercially available from VMware. In an example, management node 114 may be communicatively connected to the data center via a network to manage the data center. An example network can be a managed Internet protocol (IP) network administered by a service provider. For example, the network may be implemented using wireless protocols and technologies, such as Wi-Fi, WiMAX, and the like. In other examples, the network can also be a packet-switched network such as a local area network, wide area network, metropolitan area network, Internet network, or other similar type of network environment. In yet other examples, the network may be a fixed wireless network, a wireless local area network (LAN), a wireless wide area network (WAN), a personal area network (PAN), a virtual private network (VPN), intranet or other suitable network system and includes equipment for receiving and transmitting signals.

As shown in FIG. 1A, management node 114 may execute a monitoring application 116 to analyze performance of the endpoints. For example, monitoring application 116 may be VMware® vRealize Operations (vROps), VMware® Wavefront™, Grafana, and the like. In an example, first endpoint 102 executes a remote collector 104 (e.g., an application remote collector (ARC) or a cloud proxy) to monitor the plurality of endpoints (e.g., second endpoint 106) and send monitored information to monitoring application 116 running on management node 114 (e.g., an on-premises server or a cloud-based server). For example, remote collector 104 may receive the metrics (e.g., performance metrics) from monitoring agent 108 of second endpoint 106 and transmit the metrics to monitoring application 116 for metric analysis. In some examples, remote collector 104 includes a data plane and a control plane for communicating with second endpoint 106. For example, the ARC includes a data plane provided by Erlang message queueing telemetry transport (Erlang MQTT message Broker or EMQTT) via a MQTT Protocol and a control plane provided via Salt (e.g., a configuration management and orchestration tool). In the example software as a service (SaaS) platform, the cloud proxy includes a data plane provided by an Apache HTTPD web server via hypertext transfer protocol secure (HTTPS) protocol and a control plane provided via Salt.

As shown in FIG. 1A, second endpoint 106 may include monitoring agent 108 to monitor second endpoint 106. In an example, monitoring agent 108 may be installed in second endpoint 106 to fetch metrics from various components of second endpoint 106. For example, monitoring agent 108 may real-time monitor second endpoint 106 to collect the metrics (e.g., telemetry data) associated with an application or an operating system running in second endpoint 106. Example monitoring agent 108 may be Telegraf agent, Collectd agent, or the like. Example metrics may include performance metric values associated with at least one of central processing unit (CPU), memory, storage, graphics, network traffic, or the like.

Considering an example of an on-premises platform, second endpoint 106 may host monitoring agent 108 (e.g., Telegraf agent) for metric collection, a service discovery agent (e.g., a unified collection proxy (UCP) minion agent) for service discovery, and a configuration manager (e.g., a Salt minion) for control actions. The Telegraf agent and the UCP minion agent of the data plane may publish metrics to the EMQTT message broker running in the ARC. Further, the Salt minion of the control plane may communicate with a Salt master running in the ARC. Further, control commands such as updating the agents, starting/stopping the agents, and the like may be carried out via the Salt minions upon the request of the Salt master.

In an example SaaS platform, second endpoint 106 may host monitoring agent 108 (e.g., Telegraf Agent) for metric collection, a UCP minion agent for service discovery, and a Salt minion for control actions. Further, the Telegraf agent and the UCP minion of the data plane may publish metrics to the Apache HTTPD web server running in the cloud proxy. Furthermore, the Salt minion of the control plane may communicate with the Salt master running in the cloud proxy.

Further, second endpoint 106 includes process tree generation unit 110 in communication with monitoring agent 108. During operation, process tree generation unit 110 may receive a command to monitor an input process running in second endpoint 106. In an example, process tree generation unit 110 may receive the command to monitor an operating system process (e.g., a Linux process), an operating system service (e.g., Windows service), or both running in the second endpoint. In another example, process tree generation unit 110 may receive the command to monitor the process or service associated with an application running in the second endpoint. Upon receiving the command, process tree generation unit 110 may download a process tree creation script 112 from remote collector 104 or from an external server.

Furthermore, process tree generation unit 110 may execute process tree creation script 112 to generate a configuration file for monitoring agent 108. For example, the configuration file may store configuration information related to a type of diagnostic information that needs to be collected using a plugin. In this example, the configuration file may include a process tree indicating a hierarchical relationship of the input process with other processes. In an example, process tree generation unit 110 may execute process tree creation script 112 to iteratively retrieve a plurality of process identifiers associated with a plurality of processes having the hierarchical relationship with the input process until a stop condition is met. The stop condition may include determining a child process having no children, determining a parent process as a parent of all operating system processes (e.g., if the parent process is an initialization process in Linux operating system having a process identifier 1), determining a parent process as an operating system service execution process (e.g., if the parent process is a services.exe process in windows), identifying a parent or child process crossing a boundary/range beyond which the parent or child process unlikely to affect a performance of the input process (e.g., a docker container daemon process, a Kubernetes pod, or the like), or any combination thereof. Further, the configuration file for the monitoring agent may be generated based on the retrieved process identifiers.

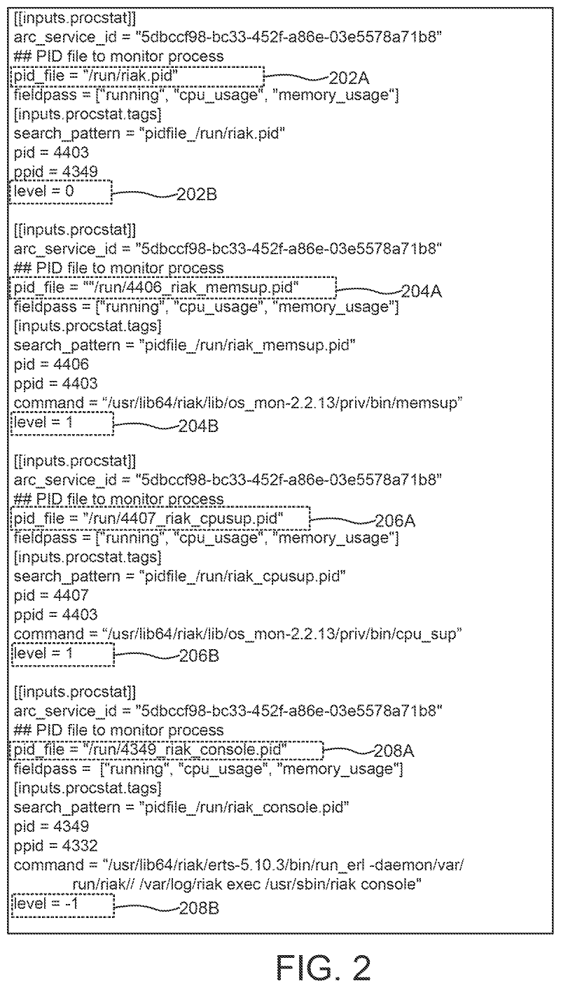

In an example, process tree generation unit 110 generates the configuration file including the process tree to monitor parent and child processes in the boundary which affects a performance of the input process. The boundary can be user-defined. In another example, the boundary can be automatically determined depending on whether the process to be monitored is running in a docker container, a Kubernetes pod, or any virtual environment. Further, process tree generation unit 110 may enable monitoring agent 108 to monitor the processes in the process tree based on the configuration file. An example configuration file is depicted in FIG. 2.

In an example, monitoring agent 108 may collect performance metrics associated with the processes in the process tree. The performance metrics may include a hierarchical level of each process in the process tree. Further, the performance metrics associated with each process in the process tree may include a process identifier, a parent process identifier, a hierarchical level, a search pattern to group each process in the process tree to the input process, or any combination thereof. Further, monitoring agent 108 may transmit the collected performance metrics and information associated with the processes in the process tree to the remote collector.

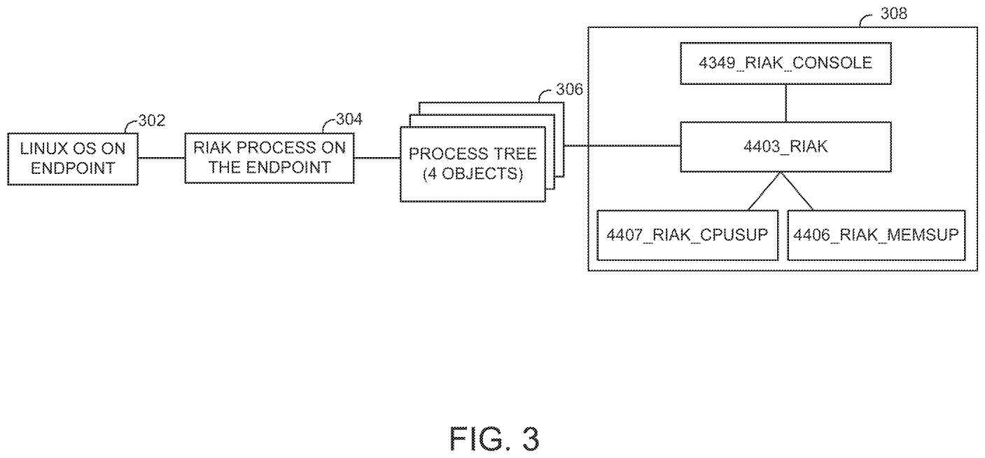

Furthermore, remote collector 104 may receive the performance metrics associated with the processes in the process tree. Further, remote collector 104 may construct a relationship tree indicating a hierarchical relationship of the input process with other processes using the hierarchical level of each process. An example relationship tree is depicted in FIG. 3. Further, remote collector 104 may send the relationship tree and the performance metrics associated with the processes in the relationship tree to monitoring application 116 for performance analysis.

FIG. 1B is a block diagram of example system 100 of FIG. 1A, depicting additional features. Similarly named elements of FIG. 1B may be similar in structure and/or function to elements described in FIG. 1A. As shown in FIG. 1B, second endpoint 106 includes a validation unit 152 to implement a validation script 154. In an example, validation script 154, when executed, is to validate the hierarchical relationship of the processes in the process tree of the configuration file. In response to detecting a change in a process of the process tree (e.g., if any change in process identifier or parent process identifier is detected), validation unit 152 may invoke process tree creation script 112 to generate the configuration file with a modified process tree reflecting the change in the process. For example, validation script 154 may check whether the configuration file includes valid process identifiers (i.e., pids), valid parent process identifiers (i.e., ppids), or both, and recreate the process tree in case if any process restarts. In this example, the UCP minion in second endpoint 106 may execute validation script 154 at every metric collection interval to check for the validity of the process tree in the generated configuration file. In case any of the pids or ppids has changed, process tree creation script 112 may be invoked to recreate the configuration file and monitoring agent 108 may be restarted.

Examples described herein generate the configuration file for monitoring agent 108, which may facilitate in monitoring any native applications running in second endpoint 106 (e.g., by providing a feature to monitor any Linux process and Windows service). For example, for monitoring a Linux process, a user can provide the process's bin name, a pid file path, or a command line regex. Further, for monitoring a Windows service, the user can provide a service name from a services.msc utility. Further, examples described herein enable to monitor non-curated applications by monitoring component processes and services of the non-curated applications, which may provide an insight into the non-curated applications' performance. Thus, examples described herein facilitate in obtaining “availability”, “CPU usage”, and “memory usage” metrics for any Linux process and Windows service running on second endpoint 106.

In some examples, the functionalities described in FIGS. 1A and 1B, in relation to instructions to implement functions of remote collector 104, monitoring agent 108, process tree generation unit 110, validation unit 152, and any additional instructions described herein in relation to the storage medium, may be implemented as engines or modules including any combination of hardware and programming to implement the functionalities of the modules or engines described herein. The functions of remote collector 104, monitoring agent 108, process tree generation unit 110, and validation unit 152 may also be implemented by a processor. In examples described herein, the processor may include, for example, one processor or multiple processors included in a single device or distributed across multiple devices.

FIG. 2 is an example configuration file (e.g., generated by process tree generation unit 110 of FIGS. 1A and 1B) indicating a hierarchical relationship of an input process with other processes. An example configuration file may be named in a format “<arc_service_id>.conf” as shown in FIG. 2. Further, when any new process or service is activated by a user, a new configuration file including a hierarchy of processes may be generated. The example configuration file “<arc_service_id>.conf” includes process identifiers (i.e., pid), parent process identifier tags (i.e., ppid), and level tags to maintain the hierarchy. In an example, a level tag value 0 may indicate that a process is a base process, which is a user input. Further, values for the level tags may increase for children and decrease for parents. Furthermore, the level tags in the configuration file may facilitate to construct a relationship tree at a remote collector (e.g., remote collector 104 of FIGS. 1A and 1B), i.e., at an adapter (e.g., AppOSAdapter) of a cloud proxy, for instance.

In the example configuration file of FIG. 2, a process 202A with a pid 4403 is an input process. As shown in 202B, process 202A is assigned a level 0, indicating that process 202A is the input process. As shown in 204B and 206B, respectively, the processes at level 1 include process 204A having pid 4406 and process 206A having pid 4407, which are child processes of the process 202A. As shown in 208B, the process at level −1 includes process 208A having pid 4349, which is a parent process of process 202A. Similarly, processes at levels 2, 3, or the like can be the hierarchal child processes of process 202A and processes at levels −2, −3, or the like can be the hierarchal parent processes of process 202A in a same order.

FIG. 3 is an example relationship tree constructed based on the configuration file of FIG. 2. In an example, a remote collector (e.g., remote collector 104 of FIGS. 1A and 1B) may receive performance metrics associated with processes in the process tree. Further, the remote collector may construct a relationship tree indicating a hierarchical relationship of an input process with other processes using a hierarchical level of each process. For example, the performance metrics may be sent to the remote collector (e.g., to AppOSAdapter of the cloud proxy) every collection cycle. The performance metrics sent for constructing the relationship tree may include process identifiers, parent process identifiers, level tags, search patterns, and the like. For example, the search pattern tag may group the parent and the process metrics. Further, the level tags may help in mapping the processes.

In the example shown in FIG. 3, Linux operating system (OS) may be running on an endpoint, at 302. At 304, the input process to be monitored on the endpoint may be “riak process” (e.g., process 202A of FIG. 2) associated with the Linux operating system. Further, the performance metrics associated with the riak process may be received by a remote collector. In an example, the remote collector may receive the process tree including 4 objects/processes as indicated at 306. The 4 processes may include pids 4403, 4407, 4406, and 4349 as described in FIG. 2. As depicted at 308, the remote collector may construct the relationship tree including a hierarchical relationship of input process (i.e., pid 4403) with other processes (i.e., pids 4406, 4407, and 4349) based on the assigned level tags in the configuration file. Thus, examples described herein generate the configuration file which includes hierarchical information of the processes along with the “availability”, “CPU usage”, and “memory usage” metrics for each process.

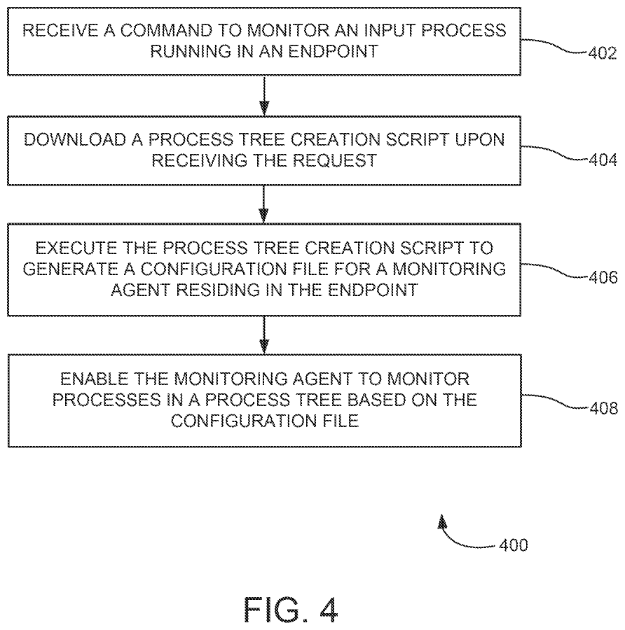

FIG. 4 is a flow diagram illustrating an example computer-implemented method 400 for generating a configuration file for a monitoring agent to monitor processes in a process tree. Process 400 depicted in FIG. 4 represents generalized illustrations, and other processes may be added, or existing processes may be removed, modified, or rearranged without departing from the scope and spirit of the present application. In addition, process 400 may represent instructions stored on a computer-readable storage medium that, when executed, may cause a processor to respond, to perform actions, to change states, and/or to make decisions. Alternatively, process 400 may represent functions and/or actions performed by functionally equivalent circuits like analog circuits, digital signal processing circuits, application specific integrated circuits (ASICs), or other hardware components associated with the system. Furthermore, the flow chart is not intended to limit the implementation of the present application, but rather the flow chart illustrates functional information to design/fabricate circuits, generate machine-readable instructions, or use a combination of hardware and machine-readable instructions to perform the illustrated process.

At 402, a command to monitor an input process running in an endpoint may be received. For example, a user may initiate a plugin activation of processes or services by providing an input such as a process bin name, command line regex/pid file path, or service name. In an example, for monitoring a Linux process, a procstat plugin may be used in a Telegraf agent. For monitoring a Windows service, a combination of Telegraf's procstat and Windows services plugins may be used.

At 404, a process tree creation script may be downloaded upon receiving the command. At 406, the process tree creation script may be executed to generate a configuration file for a monitoring agent running in the endpoint. In an example, the configuration file includes a process tree indicating a hierarchical relationship of the input process with other processes. In some examples, the configuration file may be generated in addition to a default configuration file of the monitoring agent. Further, the configuration file may be stored in a default configuration folder of the monitoring agent.

In an example, the hierarchical relationship of the processes in the process tree of the configuration file may be validated. The process tree creation script may be invoked to generate the configuration file with a modified process tree reflecting a change in the process in response to detecting the change in a process of the process tree. Further, the monitoring agent may be enabled to monitor the processes in the process tree upon validating the hierarchical relationship.

For example, the validation script may be executed as part of UCP minion at every metric collection interval to recreate the process tree when a change in a process of the process tree is detected. In an example, the process tree creation script may obtain the process identifier of the mentioned Linux and/or Windows processes iteratively till a stop condition mentioned below is met to obtain the process identifiers of the parent and all children processes of the input process. The stop condition for the process tree may include at least one of:
when a child process having no children (e.g., when a child process identifier has no more children).
when a parent process is a parent of all operating system processes (e.g., If a parent process id is an initialization process in the Linux operating system having process identifier 1).
when a parent process is an operating system service execution process (e.g., if the parent process is a services.exe process in the windows operating system).
identify a parent or child process crossing a boundary beyond which the parent or child process unlikely to affect a performance of the input process (e.g., if the process crosses a bounded context such as in a docker container daemon process, a Kubernetes pod, and the like).

Further, in case of a Linux endpoint, for each of the parent and child processes, additional blocks of Telegraf plugin entries (e.g., inputs.procstat plugins) may be appended to the new Telegraf configuration file created at custom Telegraf configuration directory default location (e.g.,/opt/vmware/ucp/ucp-telegraf/etc/telegraf/telegraf.d). For Windows endpoints, the same function may be achieved by using a combination of Windows services plugins (e.g., inputs.win_services) and Telegraf plugins (e.g., inputs.win_perf_counters).

At 408, the monitoring agent may be enabled to monitor the processes in the process tree based on the configuration file. In an example, enabling the monitoring agent to monitor the processes in the process tree including collecting performance metrics associated with the processes in the process tree and transmitting the collected performance metrics and information associated with the processes in the process tree to the remote collector. The performance metrics associated with each process in the process tree may include a process identifier, a parent process identifier, a hierarchical level, a search pattern to group each process in the process tree to the input process, or any combination thereof. The remote collector may construct a relationship tree indicating a hierarchical relationship of the input process with other processes using the hierarchical level of each process and the relationship tree. Further, the remote collector may send the relationship tree and the performance metrics associated with each process in the process tree to a monitoring application for performance analysis of the input process.

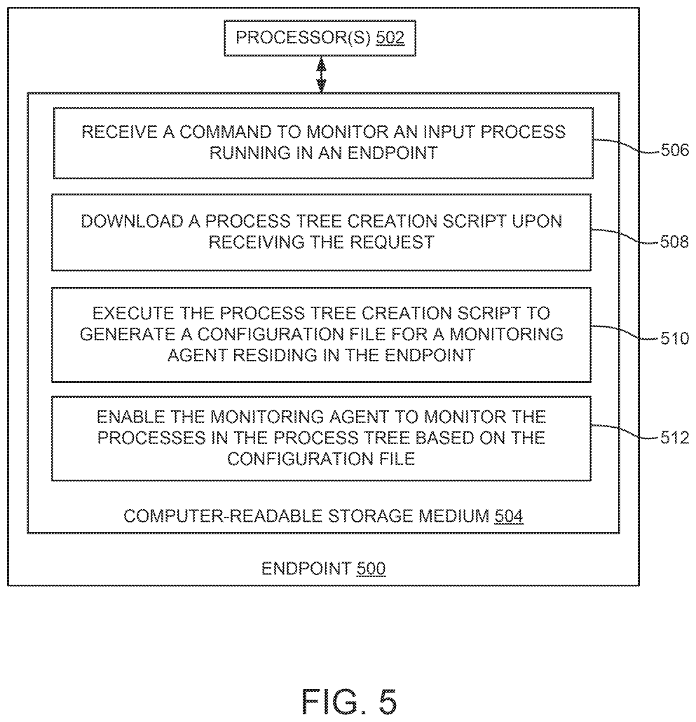

FIG. 5 is a block diagram of an example endpoint 500 including non-transitory computer-readable storage medium 504 storing instructions to generate a configuration file including a process tree for monitoring processes in endpoint 500. Endpoint 500 may include a processor 502 and computer-readable storage medium 504 communicatively coupled through a system bus. Processor 502 may be any type of central processing unit (CPU), microprocessor, or processing logic that interprets and executes machine-readable instructions stored in computer-readable storage medium 504. Computer-readable storage medium 504 may be a random-access memory (RAM) or another type of dynamic storage device that may store information and machine-readable instructions that may be executed by processor 502. For example, computer-readable storage medium 504 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, computer-readable storage medium 504 may be a non-transitory machine-readable medium. In an example, computer-readable storage medium 504 may be remote but accessible to endpoint 500.

Computer-readable storage medium 504 may store instructions 506, 508, 510, and 512. Instructions 506 may be executed by processor 502 to receive a command to monitor an input process running in an endpoint. Instructions 508 may be executed by processor 502 to download a process tree creation script upon receiving the command.

Instructions 510 may be executed by processor 502 to execute the process tree creation script to generate a configuration file for a monitoring agent running in the endpoint. The configuration file may include a process tree indicating a hierarchical relationship of the input process with other processes. In an example, instructions 510 to execute the process tree creation script to generate the configuration file include instructions to generate the configuration file including the process tree to monitor parent and child processes in a boundary which affects a performance of the input process. In other examples, instructions 510 to execute the process tree creation script to generate the configuration file may include instructions to iteratively retrieve a plurality of process identifiers associated with a plurality of processes having the hierarchical relationship with the input process until a stop condition is met.

Instructions 512 may be executed by processor 502 to enable the monitoring agent to monitor the processes in the process tree based on the configuration file. Further, computer-readable storage medium 504 may store instructions to collect performance metrics associated with the processes in the process tree and transmit the collected performance metrics and information associated with the processes in the process tree to a remote collector. For example, the information associated with the processes include a process identifier, a parent process identifier, a hierarchical level, a search pattern to group each process in the process tree to the input process, or any combination thereof.

Some or all of the system components and/or data structures may also be stored as contents (e.g., as executable or other machine-readable software instructions or structured data) on a non-transitory computer-readable medium (e.g., as a hard disk; a computer memory; a computer network or cellular wireless network or other data transmission medium; or a portable media article to be read by an appropriate drive or via an appropriate connection, such as a DVD or flash memory device) so as to enable or configure the computer-readable medium and/or one or more host computing systems or devices to execute or otherwise use or provide the contents to perform at least some of the described techniques.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A system comprising:
a first endpoint executing a remote collector; and
a second endpoint in communication with the first endpoint, wherein the remote collector is to monitor the second endpoint and send monitored information to a monitoring application, the second endpoint comprising:
a monitoring agent; and
a process tree generation unit in communication with the monitoring agent, wherein the process tree generation unit is to:
receive a command to monitor an input process running in the second endpoint;
download a process tree creation script from the remote collector upon receiving the command;
execute the process tree creation script to generate a configuration file for the monitoring agent, the configuration file including a process tree indicating a hierarchical relationship of the input process with other processes; and
enable the monitoring agent to monitor the processes in the process tree based on the configuration file.

2. The system of claim 1, wherein the monitoring agent is to:
collect performance metrics associated with the processes in the process tree, wherein the performance metrics comprise a hierarchical level of each process in the process tree; and
transmit the collected performance metrics and information associated with the processes in the process tree to the remote collector.

3. The system of claim 2, wherein the remote collector is to:
receive the performance metrics associated with the processes in the process tree; and
construct a relationship tree indicating a hierarchical relationship of the input process with other processes using the hierarchical level of each process.

4. The system of claim 2, wherein the performance metrics associated with each process in the process tree comprise a process identifier, a parent process identifier, a hierarchical level, a search pattern to group each process in the process tree to the input process, or any combination thereof.

5. The system of claim 1, wherein the second endpoint comprises:
a validation unit to implement a validation script, wherein the validation script, when executed, is to validate the hierarchical relationship of the processes in the process tree of the configuration file.

6. The system of claim 5, wherein the validation unit is to:
in response to detecting a change in a process of the process tree, invoke the process tree creation script to generate the configuration file with a modified process tree reflecting the change in the process.

7. The system of claim 1, wherein each of the first endpoint and the second endpoint comprise a virtual machine, a container, or a physical host computing system.

8. The system of claim 1, wherein the process tree generation unit is to:
receive the command to monitor an operating system process, an operating system service, or both running in the second endpoint.

9. The system of claim 1, wherein the process tree generation unit is to:
receive the command to monitor the process or service associated with an application running in the second endpoint.

10. The system of claim 1, wherein the process tree generation unit is to execute the process tree creation script to:
iteratively retrieve a plurality of process identifiers associated with a plurality of processes having the hierarchical relationship with the input process until a stop condition is met, wherein the stop condition comprises determining a child process having no children, determining a parent process as a parent of all operating system processes, determining a parent process as an operating system service execution process, identifying a parent or child process crossing a boundary beyond which the parent or child process unlikely to affect a performance of the input process, or any combination thereof; and
generate the configuration file for the monitoring agent based on the retrieved process identifiers.

11. The system of claim 1, wherein the process tree generation unit is to.
generate the configuration file including the process tree to monitor parent and child processes in a boundary which affects a performance of the input process.

12. A computer-implemented method comprising:
receiving a command to monitor an input process running in an endpoint;
downloading a process tree creation script upon receiving the command;
executing the process tree creation script to generate a configuration file for a monitoring agent running in the endpoint, the configuration file including a process tree indicating a hierarchical relationship of the input process with other processes; and
enabling the monitoring agent to monitor the processes in the process tree based on the configuration file.

13. The computer-implemented method of claim 12, wherein enabling the monitoring agent to monitor the processes in the process tree comprises:
collecting performance metrics associated with the processes in the process tree; and
transmitting the collected performance metrics and information associated with the processes in the process tree to a remote collector, wherein the information associated with the processes comprise a process identifier, a parent process identifier, a hierarchical level, a search pattern to group each process in the process tree to the input process, or any combination thereof.

14. The computer-implemented method of claim 13, wherein the performance metrics associated with each process in the process tree comprise a process identifier, a parent process identifier, a hierarchical level, a search pattern to group each process in the process tree to the input process, or any combination thereof.

15. The computer-implemented method of claim 12, further comprising:
validating the hierarchical relationship of the processes in the process tree of the configuration file; and
enabling the monitoring agent to monitor the processes in the process tree upon validating the hierarchical relationship.

16. The computer-implemented method of claim 12, further comprising:
in response to detecting a change in a process of the process tree, invoking the process tree creation script to generate the configuration file with a modified process tree reflecting the change in the process.

17. A non-transitory computer-readable storage medium comprising instructions executable by a processor of an endpoint to:
receive a command to monitor an input process running in the endpoint;
download a process tree creation script upon receiving the command;
execute the process tree creation script to generate a configuration file for a monitoring agent running in the endpoint, the configuration file including a process tree indicating a hierarchical relationship of the input process with other processes; and
enable the monitoring agent to monitor the processes in the process tree based on the configuration file.

18. The non-transitory computer-readable storage medium of claim 17, further comprising instructions to:
collect performance metrics associated with the processes in the process tree; and
transmit the collected performance metrics and information associated with the processes in the process tree to a remote collector, wherein the information associated with the processes comprise a process identifier, a parent process identifier, a hierarchical level, a search pattern to group each process in the process tree to the input process, or any combination thereof.

19. The non-transitory computer-readable storage medium of claim 17, wherein instructions to execute the process tree creation script to generate the configuration file comprise instructions to:
generate the configuration file including the process tree to monitor parent and child processes within a boundary which affects a performance of the input process.

20. The non-transitory computer-readable storage medium of claim 19, wherein instructions to execute the process tree creation script to generate the configuration file comprise instructions to:
iteratively retrieve a plurality of process identifiers associated with a plurality of processes having the hierarchical relationship with the input process until a stop condition is met.
